(19) United States
(12) Patent Application Publication
(10) Pub. No.: US 2012/0269320 A1
(43) Pub. Date: Oct. 25, 2012

(54) WASTE RECEPTACLE

(75) Inventor: Nick Karlovasitis, Chippendale (AU)

(73) Assignee: UNIVERSITY OF TECHNOLOGY, SYDNEY, Ultimo, New South Wales (AU)

(21) Appl. No.: 13/502,237

(22) PCT Filed: Oct. 15, 2010
(86) PCT No.: PCT/AU2010/001363

§ 371 Date: Jul. 3, 2012

(30) Foreign Application Priority Data
Oct. 16, 2009 (AU) 2009905033

(51) Int. Cl. B65F 1/14; G01N 23/04

(52) U.S. Cl. 378/57; 206/459.5; 220/500; 220/486; 220/4.28; 220/476

(57) ABSTRACT

A waste receptacle, including a housing; an opening for ingress of waste products into the housing, and, a receptor provided about at least a portion of an extremity of the housing. The waste receptacle is adapted to removably retain an image recording medium thereto.

### BACKGROUND OF THE INVENTION

The present invention relates to a waste receptacle, and in particular, to a waste receptacle which includes means to house an image recording medium, such that the contents of the bin may be analysed. In particular, the present invention relates to a waste receptacle which may be readily x-rayed to determine the nature and presence of the objects contained within the receptacle.

### DESCRIPTION OF THE PRIOR ART

Waste receptacles are typically placed in high traffic public areas. As such, terrorists often place explosive devices in waste receptacles, as they can readily conceal an explosive device in a highly populated location. Waste receptacles typically utilise materials which are non-visible therethrough, to conceal the contents of the waste receptacle, but utilisation of such materials however also enables concealment of explosive devices.

Typically, if an explosive device is suspected to be concealed within a waste receptacle, attempts are generally made to x-ray the waste receptacle to identify the nature of the contents therein. However, presently known waste receptacles are not particularly designed for this purpose, and as such, the size, shape and nature of materials utilised in construction of the receptacle often hinders the attempts to x-ray the receptacle.

This therefore identifies a need for a waste receptacle which lends itself to being able to be more readily x-rayed, to identify the nature of objects therein.

### SUMMARY OF THE INVENTION

The present invention seeks to provide a waste receptacle which has improvements or modifications over prior art waste receptacles, in that an image of the contents therein may be more readily obtained.

The present invention also seeks to provide a waste receptacle to which an image recording medium may be readily removably attached such that an image utilising x-radiation or other electromagnetic radiation may be obtained to identify the contents thereof.

In one broad form, the present invention provides a waste receptacle, including:

a housing;

an opening for ingress of waste products into said housing; and,

a receptor provided about at least a portion of an extremity of said housing, adapted to removably retain an image recording medium thereto.

Preferably, said receptor includes a slot or the like into which said image recording medium is adapted to be removably slid.

Also preferably, said housing is substantially upstanding, with said opening provided in an upper portion thereof.

Preferably, said housing is-substantially rectangular in cross-section, and wherein said receptor is provided substantially about a first wall thereof.

Also preferably, a second wall, opposed to said first wall, is formed of polycarbonate or like plastics material which substantially permits transmission of x-radiation or other electromagnetic radiation therethrough.

Preferably, said second wall is configured to permit selective viewing of contents therethrough, depending on the viewing angle.

Most preferably, said second wall is concertina or louvre shaped.

Also preferably, said second wall is adapted to receive information, advertising or like signage attached thereto.

Preferably, said second wall is hinged to said housing to permit access to empty the contents of said housing.

Preferably, the waste receptacle includes third and fourth walls each spaced apart and substantially orthogonal to said first and second walls.

Also preferably, said third and fourth walls are each formed of perforated material.

Preferably, said third and fourth walls are each attached to said housing using clasps which release relatively easily with internal pressure but which obviate removal or tampering from externally.

Also preferably, the waste receptacle includes an upper surface member incorporating said opening, which is corrugated to obviate tagging and graffiti, and which substantially assists the channelling of water.

Preferably, said receptacle is of modular form, to permit the interconnection of similar receptacles adjacent thereto.

Also preferably, said receptacle is adapted to be attached to a substrate surface by mountings contained within the confines of said housing.

In a preferred form, the waste receptacle is of modular construction for interconnection to adjacent waste receptacles.

In a further broad form, the present invention provides a method of determining the contents of a waste receptacle, including the steps of:

installing an image recording medium into a receptor provided about _at least a portion of an extremity of a housing of said receptacle;

emitting electromagnetic radiation from an opposed portion of said housing; removing said image recording medium from said receptor; and

analysing an image on a small image recording medium.

Preferably, said electromagnetic radiation includes x-radiation.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 illustrates a front perspective view of a waste receptacle in accordance with a preferred embodiment of the present invention;

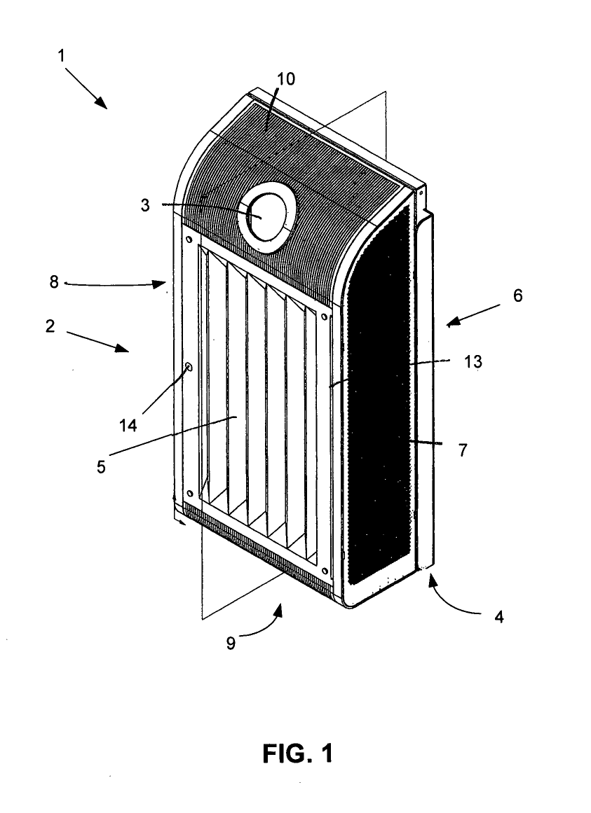

FIG. 2 illustrates a rear perspective view of the waste receptacle, with some components removed;

FIG. 3 illustrates a front view of the receptacle;

FIG. 4 illustrates a rear view of the receptacle;

FIG. 5 illustrates a left side view of the receptacle;

FIG. 6 illustrates a right side view of the receptacle;

FIG. 7 illustrates a top view of the receptacle;

FIG. 8 illustrates a bottom view of the receptacle;

FIG. 9 illustrates a front perspective view with the walls/panels removed;

FIG. 10 illustrates a right side view with the side panels removed;

FIG. 11 illustrates an exploded view of the bottom of the sliding receptor; and

FIG. 12 illustrates how, due to the modular construction of the receptacle a plurality of receptacles may be placed adjacent one to the other.

### DETAILED DESCRIPTION OF PREFERRED EMBODIMENTS

Throughout the drawings, like numerals will be used to identify similar features, except where expressly otherwise indicated.

As shown in the drawings, a waste receptacle, generally designated by the numeral 1 includes a housing 2, an opening 3 for the ingress of waste products into the housing 2, and a receptor 4 provided on an extremity of the housing 2. The receptor 4 is adapted to removably retain an image recording medium to the housing 2, as will be hereinafter described.

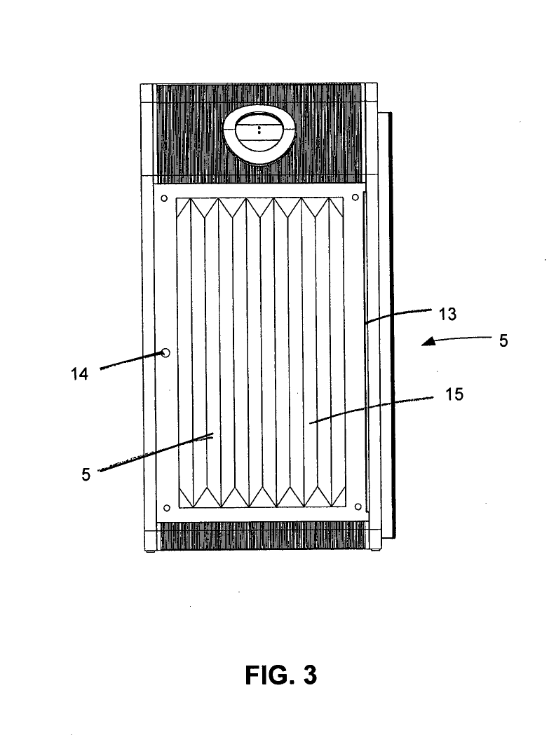

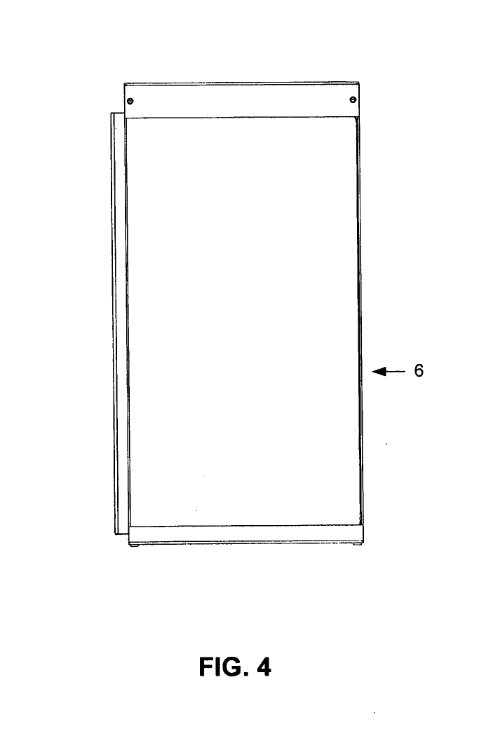

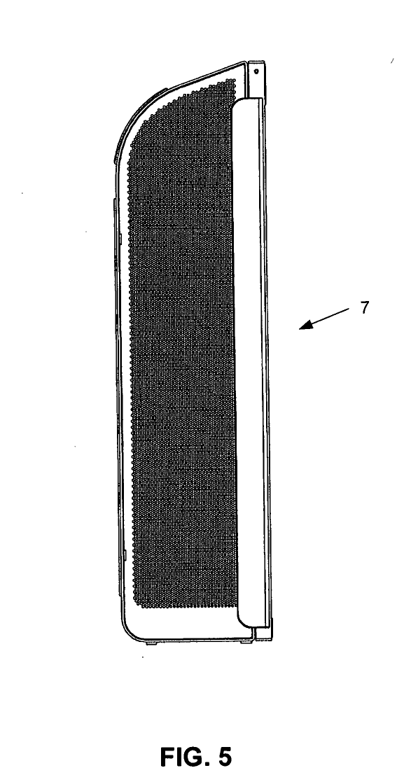

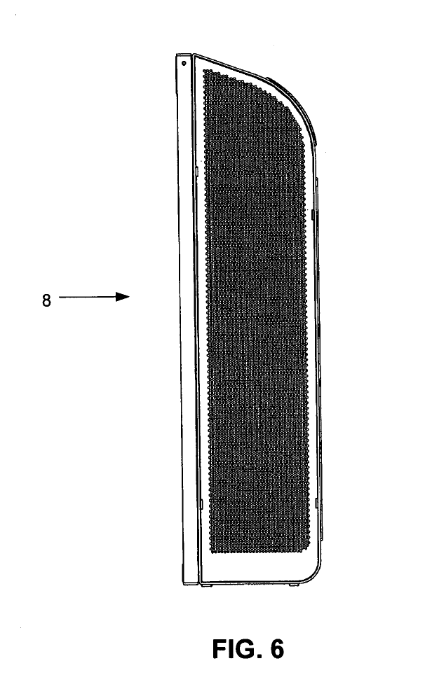

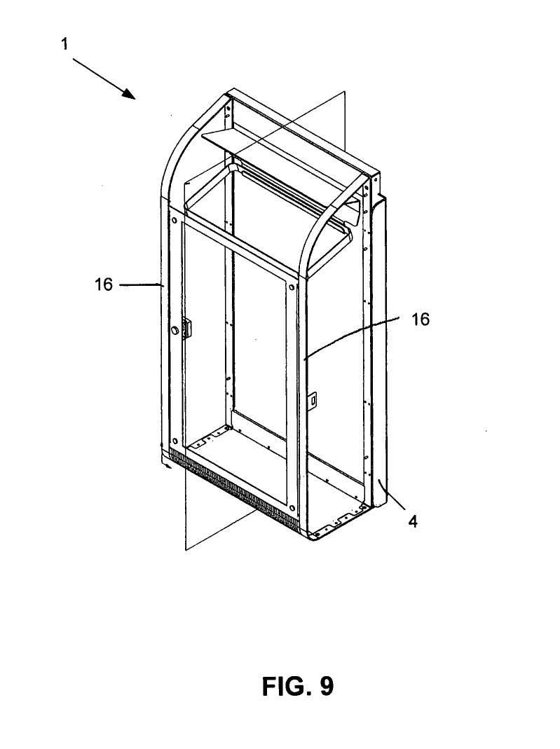

The housing 2 is effectively formed of four substantially upright standing panels, about a frame (shown in FIG. 9) including a front panel 5, a rear panel 6, a left side panel 7 and a right side panel 8. As shown in the drawings, these wall panels extend substantially vertically from a base panel 9 and terminate with a top panel 10. Details of these various panels are shown in FIGS. 3 to 7.

In the embodiment shown in the drawings, the waste receptacle 1 is of substantially rectangular cross-sectional shape, with a waste receptor orifice 3 being provided in the top surface 10 of the receptacle 1, such that any waste discarded into the receptacle 1 is contained within the housing 2.

The waste receptacle 1 of the present invention incorporates the receptor 4, shown in this embodiment as being associated with the rear wall 6 of the receptacle 1. The receptor/slide 4 may be formed in a slot-like arrangement whereby an image recording medium may be adapted to be attached to the receptor/slide and be removably slid into position to cover at least a portion of the rear wall 6 of the receptacle 1. This may be achieved by having top and bottom runners 11 and 12 respectively such that the receptor 4 can slide to and fro across the rear wall 6 of the receptacle 1.

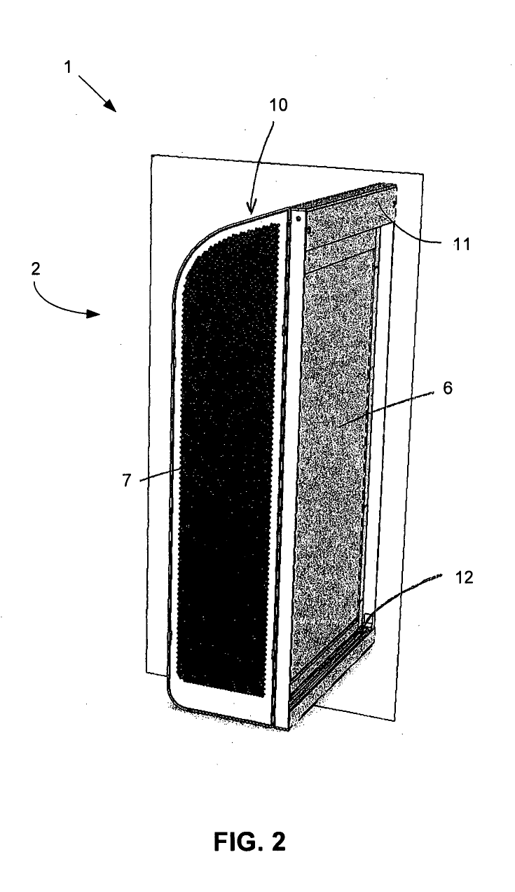

That is, in use, the receptor 4 may be slid out for attachment of the image recording medium thereto. The image recording medium may be, for example, an x-ray film. Once attached, the receptor 4 may be slid on rollers 11 and 12 across the back of the receptacle 1 to the position shown in FIG. 2, ready to x-ray the receptacle.

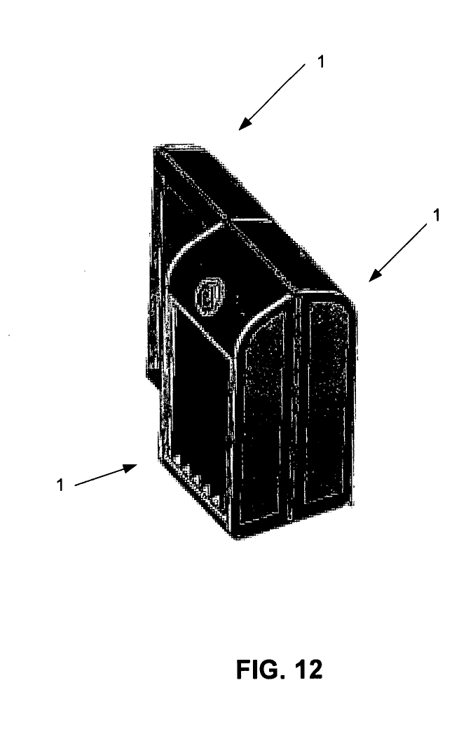

An exploded view of the bottom of the receptor/slide 4, showing its interengagement with bottom rollers 12 is shown in FIG. 12. It will be appreciated that a variety of other forms of slot-like arrangement or receptor may be utilised in order to position the image recording medium across the rear wall of the receptacle, or, on other walls including the front wall, either of the side walls or the bottom wall.

It will also be appreciated that in differently shaped receptacles, an appropriately shaped and positioned receptor may be included which substantially encapsulates at least a portion of the housing such that the contents provided within the housing can be similarly analysed by x-radiation or by other electromagnetic radiation.

Referring to FIG. 3, the front wall 5 of the waste receptacle 1 is preferably formed of polycarbonate or like plastics material, so as to permit the transmission of x-radiation or other electromagnetic radiation therethrough, when an x-ray radiation emitting apparatus is positioned in front of the front wall 5.

Furthermore, the front wall 5 may be formed to incorporate other useful features. The front wall 5 is preferably formed in a concertina or louvered configuration 15 which may permit the transmission of light readily therethrough and/or permit an observer to readily observe the contents of the waste receptacle when appropriately positioned adjacent the louvers or concertinaed walls. This would assist in visual identification of suspicious objects within the receptacle 1.

Furthermore, the configuration of the concertinaed front panel 5 also provides the ability to display public information advertising or other indicia or images on the surface(s) thereof.

The front wall 5 is also preferably provided with a hinge along one edge thereof, for example a piano hinge 13, together with a lock 14 for locking the hinged panel to the remainder of the housing 2. Construction of this front panel in this manner ensures strength and security whilst permitting ready access to empty the contents of the housing.

The side walls 7 and 8 of the housing 2 preferably provide structural rigidity to the receptacle 1, and are preferably also formed in a tamper resistant configuration. The side walls 7 and 8 are preferably formed of perforated material, such as a perforated sheet metal. This permits light transmission therethrough which again assists in visual identification of objects within the receptacle 1. The side walls 7 and 8 are preferably also attached to the housing 2 using clasps or like mounting means which can release relatively easily in the event of internal pressure, but which obviate removal or tampering from an external position. Appropriate tabs, etc for securement of the various panels are shown in FIG. 9.

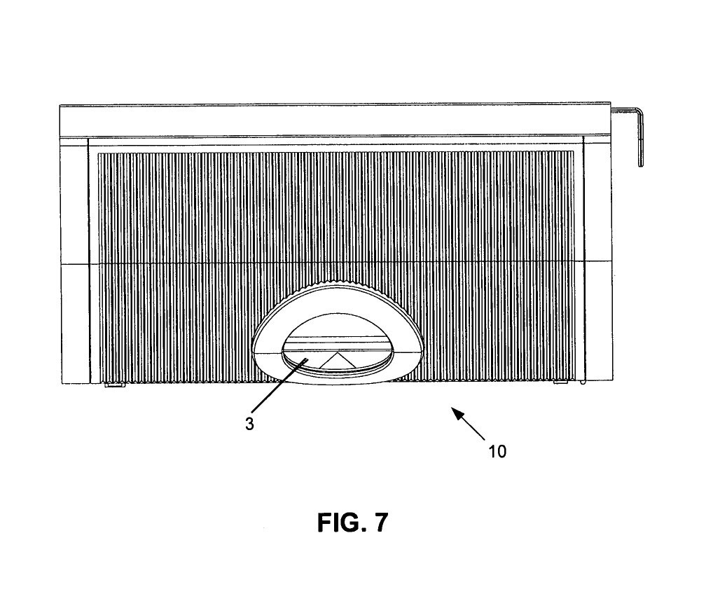

As shown in FIG. 7, the upper surface member or top 10 of the housing 2 incorporates an opening 3 through which waste products may be inserted into the receptacle 1. This upper surface 10 may preferably be corrugated to obviate tagging and graffiti, and to substantially assist in the channelling of water. This assists in self-cleaning in the event of rain or hosing of this top surface 10. This corrugated material may preferably be formed of sheet metal for improved structural strength.

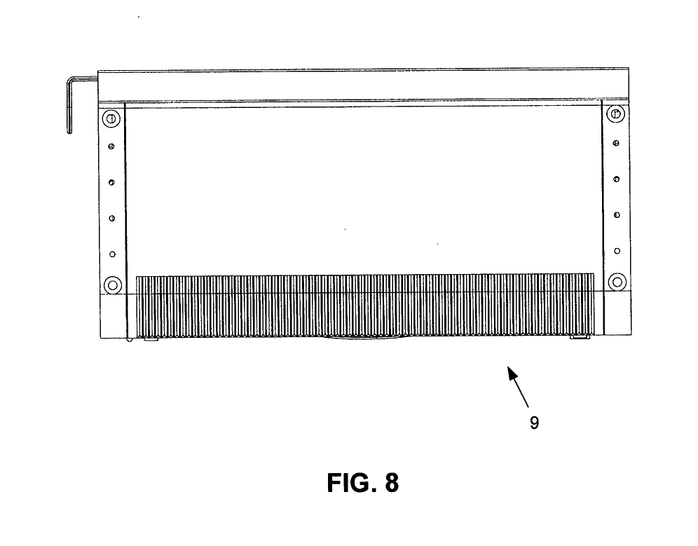

Similar corrugations may be used near the base of the receptacle 1, as shown in FIG. 8, which illustrates the bottom panel 9.

FIG. 9 illustrates the frame 16 of the receptacle 1, with the various panels (top, back. left and right) removed, such that the various tabs, etc for securement of the panels to the frame 16, and for securement of the receptacle to a substrate surface can be seen.

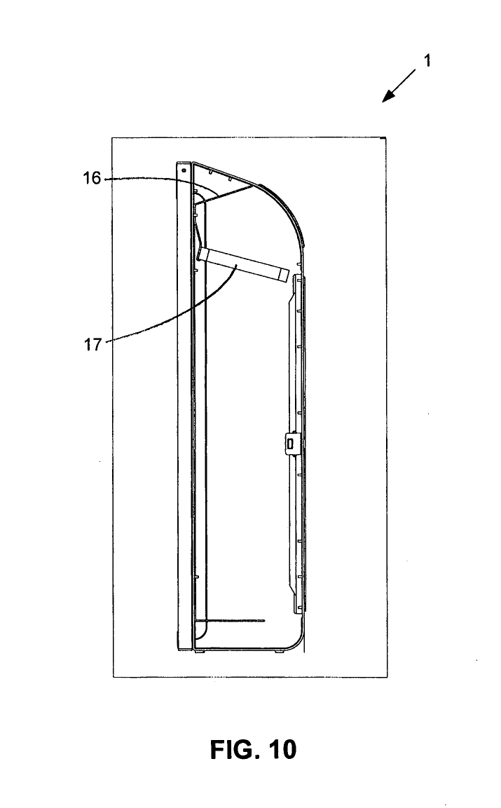

FIG. 10 illustrates a side view showing some internal aspects of the waste receptacle, including a deflector 16 which deflects waste material into the housing of the bin, and which also assists to prevent the placement of foreign objects near the top surface of the receptacle. FIG. 10 also illustrates a bag retainer mechanism 17 to which a bag or like removal container is positioned into which the waste provided through the opening 3 falls.

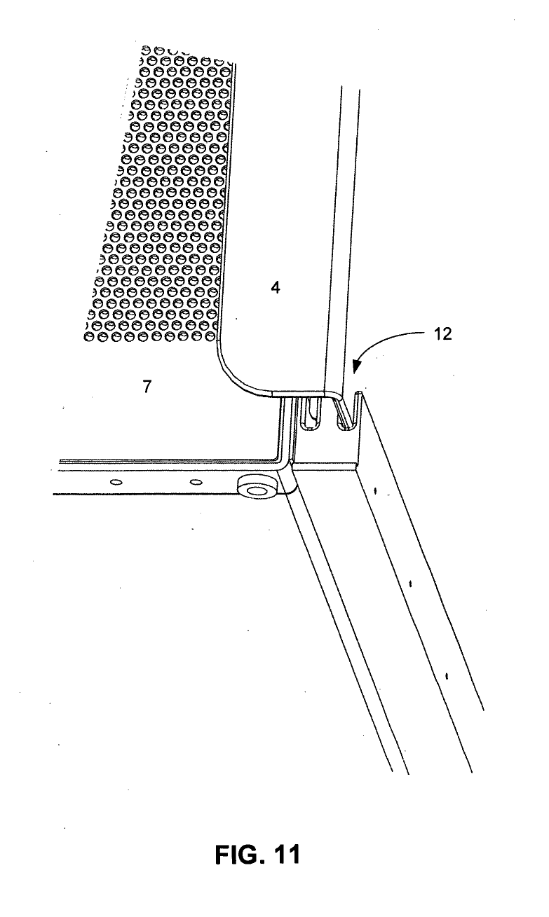

FIG. 11 details the sliding mechanism of the receptor into which the image recording medium may be removably retained. This may be formed of nylon runners or the like such that slidable insertion of an x-ray film or the like may be readily achieved. This receptor is preferably lockable such that vandalism of the device is minimised.

As illustrated in FIG. 12, the waste receptacles may be of modular construction, such that a plurality of waste receptacles may be interconnected in a variety of configurations including back to back or side by side configurations. Alternatively, the receptacles may be wall mounted. It will be appreciated that in these configurations, ready access to the image receptor is still maintained.

It will be appreciated that the waste receptacles constructed in accordance with the present invention, when positioned should preferably be attached such that they are not readily removable by vandals. For this purpose, it will be appreciated that the receptacle may be attached to a substrate surface by mountings wholly contained within the confines of the housing and only accessed when the front panel or door 5 is unlocked and opened.

It will therefore be appreciated that the waste receptacle of the present invention provides distinct features over the prior art which allows the ready identification of explosives or other objects in the receptacle to be determined and analysed by using x-radiation or other electromagnetic radiation.

In use, it will be appreciated that to determine the contents of the waste receptacle, an image recording medium may be installed in the receptor 3 provided adjacent the rear walls 6 of the housing 2. An x-radiation emitting device may then be positioned on the other side of the housing adjacent the front wall or door 5 and operated to effectively scan the contents provided within the waste receptacle. After transmission of the x-radiation or other electromagnetic radiation, the image recording medium may then be removed from the receptor by being slid out from behind the housing, and the image may therefore be readily analysed.

It will be appreciated that the present invention provides one embodiment of a waste receptacle of the present invention. Whilst a specific shape and design of a waste receptacle has been shown in the drawings, it will be appreciated by person skilled in the art that numerous variations and modifications to the shape, size, and design of the waste receptacle will be envisaged. All such variations and modifications which become apparent to persons skilled in the art should be considered to fall within the spirit and scope of the invention as broadly herein described.

1-18. (canceled)

19. A waste receptacle, including:
a housing;
an opening for ingress of waste products into said housing; and,
a receptor provided about at least a portion of an extremity of said housing, adapted to removably retain an image recording medium thereto.

20. The waste receptacle as claimed in claim 19, wherein said receptor includes a slot or the like into which said image recording medium is adapted to be removably slid.

21. The waste receptacle as claimed in claim 19, wherein said housing is substantially upstanding, with said opening provided in an upper portion thereof.

22. The waste receptacle as claimed in claim 19, wherein said housing is substantially rectangular in cross-section, and wherein said receptor is provided substantially about a first wall thereof.

23. The waste receptacle as claimed in claim 22, further comprising a second wall, opposed to said first wall, formed of polycarbonate or like plastics material which substantially permits transmission of x-radiation or other electromagnetic radiation therethrough.

24. The waste receptacle as claimed in claim 23, wherein said second wall is configured to permit selective viewing of contents therethrough, depending on the viewing angle.

25. The waste receptacle as claimed in claim 23, wherein said second wall is concertina or louvre shaped.

26. The waste receptacle as claimed in claim 23, wherein said second wall is adapted to receive information, advertising or like signage attached thereto.

27. The waste receptacle as claimed in claim 23, wherein said second wall is hinged to said housing to permit access to empty the contents of said housing.

28. The waste receptacle as claimed in claim 23, further comprising third and fourth walls each spaced apart and substantially orthogonal to said first wall and said second wall.

29. The waste receptacle as claimed in claim 28, wherein said third wall and said fourth wall are each formed of perforated material.

30. The waste receptacle as claimed in claim 28, wherein said third wall and said fourth wall are each attached to said housing using clasps which release relatively easily with internal pressure but which obviate removal or tampering from externally.

31. The waste receptacle as claimed in claim 19, further comprising an upper surface member incorporating said opening, which is corrugated to obviate tagging and graffiti, and which substantially assists the channelling of water.

32. The waste receptacle as claimed in claim 19, wherein the waste receptacle is of modular form, to permit the interconnection of similar receptacles adjacent thereto.

33. The waste receptacle as claimed in claim 19, wherein the waste receptacle is adapted to be attached to a substrate surface by mountings contained within the confines of said housing.

34. The waste receptacle as claimed in claim 19, wherein the waste respectacle is of modular construction for interconnection to adjacent waste receptacles.

35. A method of determining the contents of a waste receptacle, comprising the steps of:
installing an image recording medium into a receptor provided about at least a portion of an extremity of a housing of said receptacle;
emitting electromagnetic radiation from an opposed portion of said housing;
removing said image recording medium from said receptor; and
analysing an image on a small image recording medium.

36. The method of determining the contents of a waste receptacle as claimed in claim 35, wherein said electromagnetic radiation includes x-radiation.
